(19) United States
(12) Patent Application Publication
(10) Pub. No.: US 2020/0351564 A1
(43) Pub. Date: Nov. 5, 2020

(54) Video Playback Control Method, Apparatus, and Terminal

(71) Applicant: Guangzhou Huya Information Technology Co., Ltd., Guangzhou, Guangdong (CN)

(72) Inventors: Rongdong Zhang, Guangzhou, Guangdong (CN); Longlong Huang, Guangzhou, Guangdong (CN)

(73) Assignee: Guangzhou Huya Information Technology Co., Ltd., Guangzhou, Guangdong (CN)

(21) Appl. No.: 16/759,126

(22) PCT Filed: Aug. 8, 2018
(86) PCT No.: PCT/CN2018/099457

§ 371 Date: Apr. 24, 2020

(30) Foreign Application Priority Data
Oct. 30, 2017 (CN) 201711036443.6

(51) Int. Cl. H04N 21/472; H04N 21/6587; H04N 21/431; H04N 21/442; H04N 21/44; H04N 21/482; H04N 21/466

(52) U.S. Cl. CPC H04N 21/47217; H04N 21/6587; H04N 21/4312; H04N 21/4667; H04N 21/44; H04N 21/4826; H04N 21/44222

(57) ABSTRACT

A video playback control method, apparatus, and terminal are provided. The method includes: entering a video immersive playback mode, when it is detected that a page sliding status is a preset status; in the video immersive playback mode, determining information layout of a current video based on a preset baseline, highlighting the information layout of the current video in a page, and playing the current video after darkening areas other than the information layout of the current video on the page; switching the current video to a corresponding target video based on a pre-loaded video list in response to a preset switching instruction; and playing the target video.

### CROSS-REFERENCE TO RELATED APPLICATIONS

The present application is a national phase entry under 35 U.S.C § 371 of International Application No. PCT/CN2018/099457 filed Aug. 8, 2018, which claims priority from Chinese Application No. 201711036443.6 filed Oct. 30, 2017, all of which are hereby incorporated herein by reference.

### FIELD OF THE INVENTION

The embodiments of the present invention relate to the field of software application, and in particular, to a video playback control method, apparatus, and terminal.

### BACKGROUND OF THE INVENTION

With the rapid development of Internet technology, more and more people are using Internet-based social applications and platforms to share their works with other social users. Especially with the development of media-streaming technology, videos are becoming more and more popular among users, and video applications focus on displaying videos posted by users. Other users can browse and watch video works through social applications. At present, when users watch videos, there are too many distracting factors, making users unable to focus on watching video content.

### SUMMARY OF THE INVENTION

The purpose of the embodiments of the present invention is to provide a method and apparatus for controlling video playback, and a corresponding terminal, so that users can focus on watching the currently playing video.

To achieve this, the embodiments of the present invention adopt the following technical solutions:

In a first aspect, an embodiment of the present invention provides a video playback control method, including:

entering a video immersive playback mode, when it is detected that a page sliding status is a preset status;

in the video immersive playback mode, determining information layout of a current video based on a preset baseline, highlighting the information layout of the current video in a page, and playing the current video after darkening areas other than the information layout of the current video on the page;

switching the current video to a corresponding target video based on a pre-loaded video list in response to a preset switching instruction; and

playing the target video.

In a second aspect, an embodiment of the present invention further provides a video playback apparatus, including:

a response module, for entering a video immersive playback mode, when it is detected that a page sliding status is a preset status;

a processing module: for in the video immersive playback mode, determining information layout of a current video based on a preset baseline, highlighting the information layout of the current video in a page, and playing the current video after darkening areas other than the information layout of the current video on the page;

a video switching module, for switching the current video to a corresponding target video based on a pre-loaded video list in response to a preset switching instruction; and

a playing module, for playing the target video.

In a third aspect, an embodiment of the present invention further provides a terminal, including:

one or more processors;

memory; and

one or more applications, wherein the one or more applications are stored in the memory and configured to be executed by the one or more processors, and the one or more applications are configured to execute the video playback control method according to the first aspect.

According to a fourth aspect, the present invention also provides a computer-readable storage medium having stored therein a computer program that, when executed by a processor, implements any one of the video playback control methods according to the first aspect.

### BRIEF DESCRIPTION OF THE DRAWINGS

The above and/or additional aspects and advantages of this application will become apparent and easily understood from the following description of the embodiments in conjunction with the accompanying drawings, in which:

FIG. 1 is a schematic flowchart of an embodiment of a video playback control method according to an embodiment of the present invention;

FIG. 2 is a schematic diagram of video information layout of a video playback control method according to an embodiment of the present invention;

FIG. 3 is a schematic flowchart of another embodiment of a video playback control method according to an embodiment of the present invention;

FIG. 4 is a schematic diagram of an embodiment of a video playback control apparatus according to an embodiment of the present invention; and

FIG. 5 is a schematic diagram of a terminal structure according to an embodiment of the present invention.

### DETAILED DESCRIPTION OF THE INVENTION

Hereinafter, embodiments of the present invention will be described in detail. Examples of the embodiments are shown in the accompanying drawings, wherein the same or similar reference numerals represent the same or similar elements or elements having the same or similar functions throughout the description. The embodiments described below with reference to the drawings are exemplary and are only used to explain the present invention, and cannot be construed as limiting the present invention.

It should be understood by person of the ordinary skill in the art that unless otherwise specified, terms “a”, “one”, “the” and “said” in singular form may also be used in plural form. It should be further understood that the term “include” as used herein means presence of said feature, integer, step, operation, element and/or component, but not excluding presence of one or more additional other feature, integer, step, operation, element and/or component.

It should be understood by a person of the ordinary skill in the art that unless otherwise specified, all the terminology (including technical and scientific terms) have their ordinary meaning as understood by person of the art.

It should be understood by a person of the ordinary skill in the art that unless otherwise specified, all the terminology (including technical and scientific terms) have their ordinary meaning as understood by person of the art.

Those skilled in the art should understand that the concepts of “application”, “application program”, “application software”, and similar expressions in the embodiments of the present invention are the same concepts known to those skilled in the art and refer to a series of computer instructions and related data resources organically constructed computer software suitable for electronic operation. Unless otherwise specified, this definition is not limited by the type or level of programming language, nor by the operating system or platform on which it is running. Naturally, such concepts are not limited by any form of terminal.

Those skilled in the art should understand that the user interface and display interface referred to in the embodiments of the present invention generally refer to a display interface that can be used to send the control instruction to a smart terminal. For example, it can be an option in a settings page of an Android/IOS/Windows Phone system (or a button, which is added by the application, the same below), or it can be an option in the notification bar or interactive page called from the desktop, or an option in a page constructed by an active component of the application.

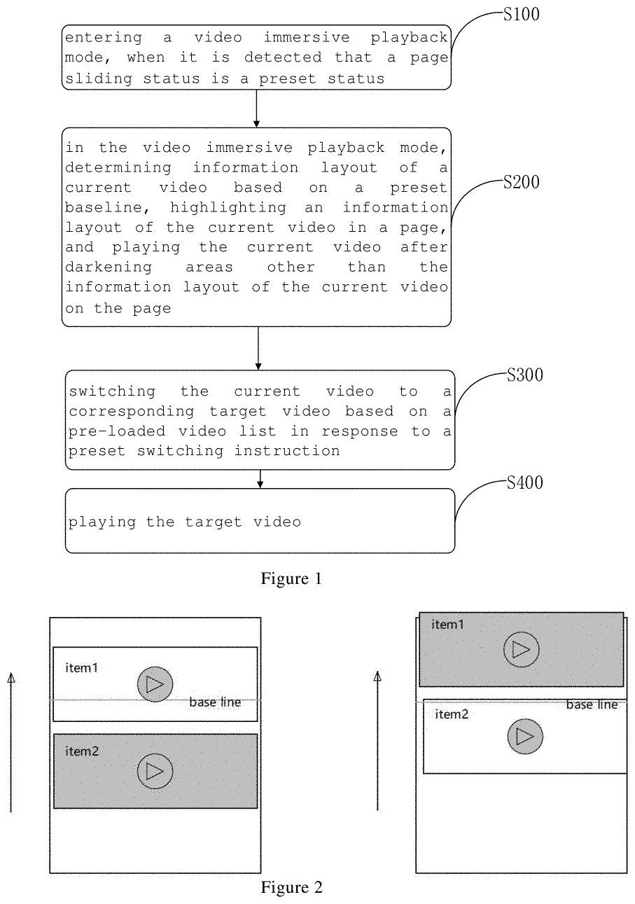

In one embodiment, an embodiment of the present invention provides a video playback control method, as shown in FIG. 1, including:

S100: entering a video immersive playback mode, when it is detected that a page sliding status is a preset status.

The embodiment of the present invention is described by using a video application as an example. The video application displays videos taken and uploaded by users of a video platform, and arranges and displays the videos uploaded by the user in a predetermined manner on a display page of the video application. Generally, when a user needs to watch a video, he can click the play button of the corresponding video to watch. This embodiment provides a video immersive playback mode, which determines whether to enter a video immersive playback mode by monitoring a sliding status of a page. Enter the video immersive playback mode, when it is detected that a page sliding status is a preset status. For example, by monitoring the sliding state of a video list on the page, when the monitored video list is in the SCROLL_STATE_FLING state, it means that the list is in an inertial sliding state. At this time, the user is quickly browsing and selecting videos, so no immersive changes are made to improve user sliding efficiency of browsing videos, saving terminal resources. When the page video list is detected to be in the SCROLL_STATE_TOUCH_SCROLL state, it means that the user is scrolling through the screen by touching the same screen and the finger is still on the screen. At this time, the page sliding status is determined to be a preset state, and then an immersive playback instruction is generated in order to enter a video immersive playback mode.

The video playback control method also includes:

S200: in the video immersive playback mode, determining information layout of a current video based on a preset baseline, highlighting the information layout of the current video in a page, and playing the current video after darkening areas other than the information layout of the current video on the page.

The video immersive playback mode is as follows: interactive elements on the page other than the current video playback interface are hidden, and only the screen of the current video is displayed and played. That is, a picture area of the current video on the page is highlighted, and other areas are darkened. Specifically, in this embodiment, in the video immersive playback mode, the information layout of the current video is determined based on a preset baseline. As shown in FIG. 2, the baseline is located at the upper and middle position of the user interface, or other locations where the baseline function can be implemented. The user interface arranges and displays the videos in the video list according to the layout shown in FIG. 2. Each video is an independent information layout. As shown in FIG. 2, item1 and item2 are independent video information layouts, and based on the baseline defined in the user interface (baseline in FIG. 2). When an upper edge and a lower edge of a video information layout cover this baseline, such as when the upper and lower edge lines of the border of item1 cover the baseline, the video corresponding to item1 is determined as the current video, and then the information layout of the current video is highlighted. At the same time, other areas except the information layout of the current video are darkened. Then the current video is played in the information layout of the highlighted current video.

The video playback control method also includes:

S300: switching the current video to a corresponding target video based on a pre-loaded video list in response to a preset switching instruction; and

S400: playing the target video.

When playing the current video, in case there is a need to switch to other videos for viewing, a preset switching instruction is generated based on a specific operation, and the video application determines the next video based on the preloaded video list in response to the switching instruction. This embodiment defines the “next video” as the target video. After the target video is determined, the current video is switched to the corresponding target video, and after switching to the target video, the information layout of the target video on the page is highlighted, and other areas except the information layout of the target video is darkened. The page is still in immersive mode. Specifically, the pre-loaded video list is a list to which the current video belongs. When the user clicks to play the current video, a service server sends the video list to which the current video belongs to a terminal video application. The video list is determined by a specific policy of the service server. For example, if the current video content is “TED Talk”, the video list may be a video list composed of a certain number of “TED Talk” videos. After receiving the preset switching instruction, the current video is switched to the target video according to the “TED Talk video list”, and the target video is also a “TED Talk” video.

After switching from the current video to the target video, the target video is played. Specifically, the target video resource is decoded, rendered, and played.

According to an embodiment of the present invention, after switching to the target video, the S400 includes:

requesting the target video resource from the service server; and

loading the target video resource returned by the service server and playing the target video.

In this embodiment, after switching from the current video to the target video, the video application requests the target video resource from the service server, then receives the target video resource returned by the service server and loads it, and then plays the target video. Similarly, the target video is still played in an immersive playback mode.

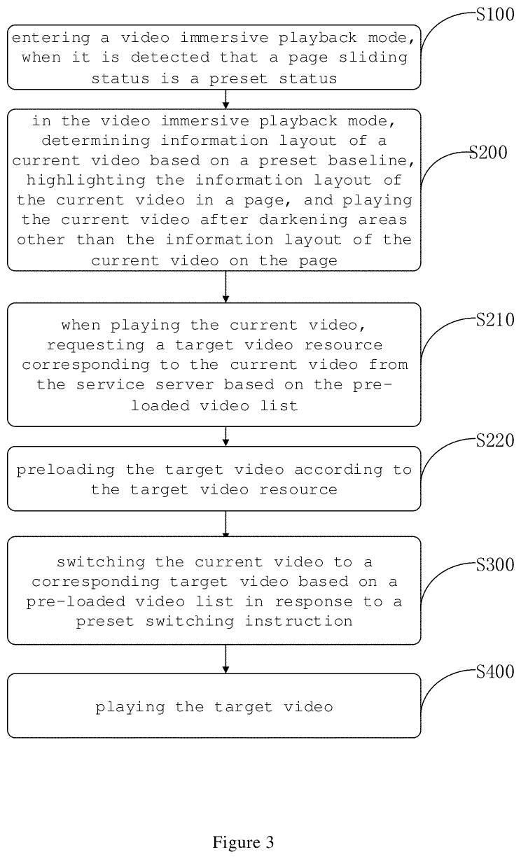

According to another embodiment of the present invention, as shown in FIG. 3, before the S300, the method further includes:

S210: when playing the current video, requesting a target video resource corresponding to the current video from the service server based on the pre-loaded video list; and

S220: preloading the target video according to the target video resource.

In this embodiment, when the video application plays the current video, the next video, that is, the target video, is determined based on the pre-loaded video list. Then the target video resource is requested from the service server. After the service server responds, the video application receives the target video resource returned by the server and preloads the target video. When the video application switches from the current video to the target video in response to a preset switching instruction, the target video is pre-loaded, and the target video can be quickly played at this time.

Preferably, the target video is preloaded only when the terminal has good performance and/or the terminal is in a good network. Because pre-loading the target video requires video encoding and decoding, and the current video, to which video encoding and decoding is also required, is still being played at this time, and, if the terminal performance is insufficient, simultaneous encoding and decoding of two channels of video will cause the current video to be choppy. In this embodiment, the performance of the terminal is evaluated first. Specifically, the video application obtains information such as the terminal model and IMEI, and then matches them with the terminal support list. If the terminal model exists in the terminal support list, it means that the performance of the terminal can meet the encoding and decoding of two videos at the same time. The terminal support list can be updated and pushed by a cloud server. When the terminal performance meets the conditions, consider again the current network status of the terminal. For example, when the current network downlink rate of the terminal reaches 1 Mbps, it is determined that the current network status of the terminal is good. At this time, the terminal can preload the target video when playing the current video, and then quickly play the target video when switching to the target video.

In an embodiment of the present invention, the preset switching instruction is generated by a user sliding on a current video. Specifically, when the user swipes from the bottom to the top on the playback interface of the current video, the switching instruction is generated, and then the video application responds to the switching instruction and switches the current video to the corresponding target video based on the preloaded video list. Subsequent playback of the target video is consistent with the foregoing embodiment, and details are not described again.

In another embodiment of the present invention, the preset switching instruction is generated after the current video playback ends. Specifically, at the end of the current video playback, a corresponding switching instruction is generated. The video application then responds to the switching instruction to switch the current video to the corresponding target video based on the pre-loaded video list. Preferably, in this embodiment, at the end of the current video playback, the target video is not switched immediately, but it is switched to the target video after a preset time. For example, within 5 seconds after the current video playback ends, the user can click to replay the current video during that time period. If the user does not click to replay the current video within 5 seconds, the current video is switched to the corresponding target video based on the preloaded video list.

In the embodiment of the present invention, the switching the current video to a corresponding target video includes:

replacing the information layout of the current video with the information layout of the target video as the information layout of a new current video; and

highlighting the information layout of the new current video and darkening other areas of the page other than the information layout of the new current video.

When switching the current video to the target video, relocate the information layout that needs to be highlighted on the page to the information layout of the target video. At this time, the information layout of the current video is replaced with the information layout of the target video as the information layout of the new current video. Then the information layout of the new current video is highlighted and other areas of the page other than the information layout of the new current video are darkened. It is still in the immersive mode after switching to the target video. Preferably, the highlighted information layout is located at the top of the page. Furthermore, if the user exits the video immersive playback mode and returns to a normal browsing mode, the current video information layout is located at the top of the user interface. Further, in the normal browsing mode, the information layout of the video also includes interactive elements of the video. The interactive elements include basic information of the video, such as video title, author, and views; video parameter settings, such as video resolution settings, bit rate settings, and time progress bar settings; and video evaluation mechanism, such as video comment button, repost button or the like. In this embodiment, the video playback interface is the information layout of the video. After entering the immersive mode, all interactive elements except the video playback interface are hidden, and only the video playback interface is displayed. This helps users to watch video content more attentively without interference from the outside world, and brings users an immersive viewing experience. Further, in an embodiment, the video application further receives an update instruction for updating the video list. Generally, the update instruction is generated by a specific operation of a user. The video application requests the server for a new video list determined based on a specific policy in response to the update instruction. For example, when the video application plays the current video, the user swipes from right to left on the playback interface of the current video to generate the update instruction. The video application requests a new video list from the server in response to the update instruction. The video application updates the local video list after receiving the new video list, and upon receiving a preset switching instruction, the video application will switch the current video to the corresponding target video based on the new video list, and then the target video is played.

Specifically, the specific policy in the foregoing embodiments include a video push policy based on a user portrait or a video push policy based on a platform operation, or a video push policy based on a video ranking.

In the video push policy based on user portrait, each user has his or her own preferred types of video to watch or preferences on the maker/creator/sharer of the videos, and from the user's viewing history of the video and the favorite video authors, a user portrait is created. Then the user portrait can roughly determine the video that the user likes to watch, and then the video can be pushed to the user based on the user portrait. In the video push policy based on a platform operation, the platform is the platform to which the video application belongs. At a certain time, the platform will formulate a video push policy based on a platform operation in order to promote the video of an author and generate a corresponding new video list based on the video and push it to the user. In the video push policy based on a video ranking, the platform will record the views, browsing time, number of comments and reshares of each video, and rank the videos according to these parameters. When the user needs to update the video list, a new video list is generated based on the preset number of videos ranked on the top of the video ranking, and the videos are pushed to the user. It can be understood that the above video push policies can be combined with each other to provide users with video content that better meets user needs. For example, when the current video playback time exceeds four-fifths, a video matching request, which carries the current video features and is based on the current video features and the user portrait, is sent to the service server, so that the service server matches videos based on the current video features and the user portrait. Then the first one-fifth of the video matched by the service server is downloaded, and then it determines whether a preset switching instruction has been received after the current video playback ends. If so, in response to the preset switching instruction, based on the preloaded video list, the current video is switched to the corresponding target video; and if no, the matching video is played. Then when the matched video playback content exceeds one-tenth, the remaining four-fifth of the matched video continues to be downloaded. In the immersive playback mode, if the user does not intervene, the matching video is automatically played, and if the user intervenes, the target video in the pre-loaded video list is played, the video he likes more is pushed to the user, and a better video viewing experience is provided.

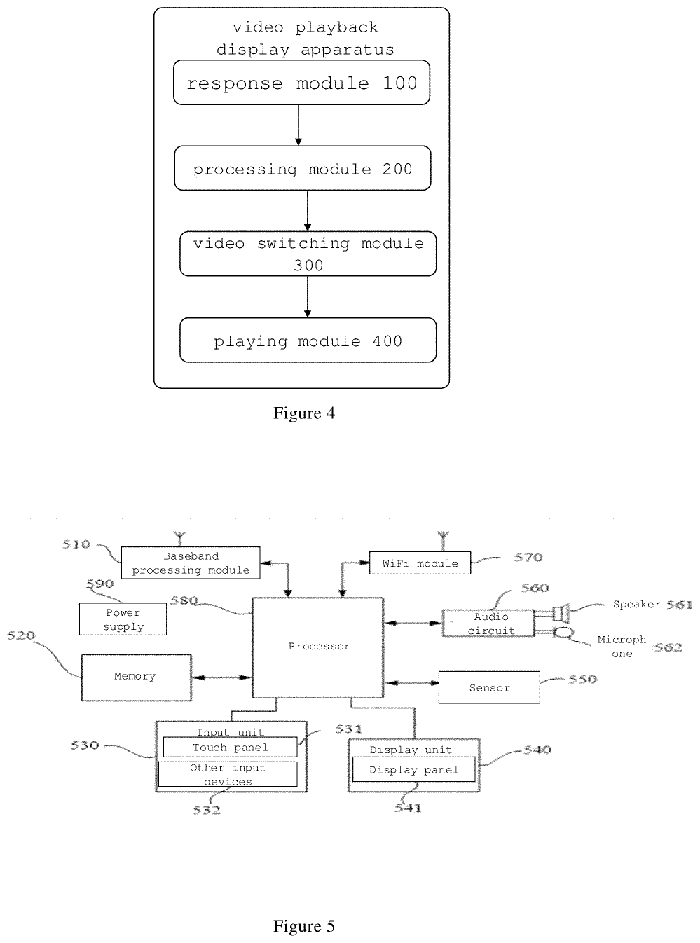

In another embodiment, the present invention provides a video playback display apparatus, as shown in FIG. 4, including:

a response module 100, for entering a video immersive playback mode, when it is detected that a page sliding status is a preset status;

a processing module 200 for determining information layout of a current video based on a preset baseline under the video immersive playback mode, highlighting the information layout of the current video on a page, and playing the current video after darkening areas other than the information layout of the current video on the page;

a video switching module 300, for switching the current video to a corresponding target video based on a pre-loaded video list in response to a preset switching instruction; and

a playing module 400, for playing the target video.

The embodiment of the present invention is described by using a video application as an example. The video application displays videos taken and uploaded by users of a video platform, and arranges and displays the videos uploaded by the user in a predetermined manner on a display page of the video application. Generally, when a user needs to watch a video, he can click the play button of the corresponding video to watch. This embodiment provides a video immersive playback mode. Whether to enter a video immersive playback mode is determined by monitoring a sliding status of a page. The video immersive playback mode is entered, when it is detected by that a page sliding status is a preset status. Specifically, the page sliding status is monitored with a response module 100, and when the monitored video list is in the SCROLL_STATE_FLING state, it means that the list is in an inertial sliding state. At this time, the user is quickly browsing and selecting videos, so no immersive changes are made in order to improve user's efficiency in scrolling through videos, saving terminal resources. When the page video list is detected to be in the SCROLL_STATE_TOUCH_SCROLL state, it means that the user is scrolling through the screen by touch and the finger is still on the screen. At this time, the page sliding status is determined to be a preset state, and then an immersive playback instruction is generated, and a video immersive playback mode is entered.

After entering the immersive playback mode, the processing module 200 highlights a picture area of the current video in the page, darkens other areas, and then plays the current video, that is, in the absence of other interactive operation, only the current video picture is displayed and played on the user interface of the video application.

When playing the current video, in case there is a need to switch to other videos for viewing, a preset switching instruction is generated based on a specific operation, and the video switching module 300 determines the next video based on the preloaded video list in response to the switching instruction. This embodiment defines the “next video” as the target video. After the target video is determined, the user interface of the video application switches from the current video to the corresponding target video.

After the video switching module 300 switches the current video to the target video, the playback module 400 plays the target video.

In another embodiment, the present invention further provides a terminal, which is used to implement the video playback control method described in the foregoing embodiments. FIG. 5 is a block diagram of part of a structure of a terminal provided in an embodiment of the present invention. For ease of description, the figure only shows part related to the embodiment of the present invention. Specific technical details are not disclosed. Please refer to the method of the embodiment of the present invention. The terminal may be any terminal device, including a mobile phone, a tablet computer, a Personal Digital Assistant (PDA), a Point of Sales (POS), a vehicle-mounted computer, and the like. Take the terminal as a mobile phone as an example.

Referring to FIG. 5, the mobile phone includes: a baseband processing module 510, a memory 520, an input unit 530, a display unit 540, a sensor 550, an audio circuit 560, a wireless fidelity (WiFi) module 570, a processor 580, and a power supply 590 and the like. Those skilled in the art can understand that the structure of the mobile phone shown in FIG. 5 does not constitute a limitation on the mobile phone, and it may include more or fewer parts than what are shown in the figure, or it can combine some parts, or it can have different parts layout.

The baseband processing module 510 may be configured to combine baseband signals to be transmitted or decode the received baseband signals.

The memory 520 may be used to store software programs and modules. The processor 580 runs the software programs and modules stored in the memory 520 to execute various functional applications and data processing of the mobile phone. The memory 520 may mainly include a storage program area and a storage data area, where the storage program area may store an operating system, an application program required for at least one function (such as a sound playback function, an image playback function or the like); and the storage data area can store data created according to the use of the mobile phone (such as audio data, phone book or the like).

The input unit 530 may be used to receive inputted numeric or character information, and generate key signal input related to user settings and function control of the mobile phone. Specifically, the input unit 530 may include a touch panel 531 and other input devices 532. The touch panel 531, also known as touch screen, can collect user's touch operations on or near the touch screen (for example, the user uses a finger, a stylus or any suitable object or tool on touch panel 531 or near touch panel 531), and drive corresponding connection device according to a preset program. It can use various types such as resistive, capacitive, infrared, and surface acoustic waves to implement the touch panel 531. In addition to the touch panel 531, the input unit 530 may further include other input devices 532. Specifically, the other input devices 532 may include, but are not limited to, one or more of a physical keyboard, function keys (such as volume control keys, switch keys and the like), a trackball, a mouse, a joystick, and the like.

The display unit 540 may be used to display information input by the user or information provided to the user and various menus of the mobile phone. The display unit 540 may include a display panel 541. Further, the touch panel 531 may cover the display panel 541. When the touch panel 531 detects a touch operation on or near the touch panel 531, the touch panel 531 transmits the touch operation to the processor 580 to determine the type of the touch event. The processor 580 then provides a corresponding visual output on the display panel 541 according to the type of the touch event. Although in FIG. 4, the touch panel 531 and the display panel 541 are implemented as two separate components to implement the input and output functions of the mobile phone, in some embodiments, the touch panel 531 and the display panel 541 may be integrated to realize the input and output functions of the mobile phone.

The mobile phone may further include at least one sensor 550, such as a light sensor, a motion sensor, and other sensors. The mobile phone can be equipped with gyroscopes, barometers, hygrometers, thermometers, infrared sensors and other sensors, and it will not be repeated again.

An audio circuit 560, a speaker 561, and a microphone 562 can provide an audio interface between the user and the mobile phone. The audio circuit 560 may transmit the received electrical signals converted from audio data to the speaker 561, and the speaker 561 converts it into a sound signal and outputs it. On the other hand, a microphone 562 converts the collected sound signals into an electrical signal, which is received by the audio circuit 560 and converted into audio data. The audio data is transmitted to the processor 580 for processing, and then sent to another mobile phone via the RF circuit 510 Or the audio data is stored into the memory 520 for further processing.

The mobile phone can help users send and receive emails, browse web pages, and access streaming media through a WiFi module 570. It provides users with wireless broadband Internet access. Although FIG. 5 shows the WiFi module 570, it can be understood that it does not belong to the necessary structure of the mobile phone, and can be omitted as needed without changing the essence of the invention.

The processor 580 is the control center of the mobile phone, and uses various interfaces and lines to connect various parts of the entire mobile phone. By running or executing software programs and/or modules stored in the memory 520 and invoking data stored in the memory 520, various functions of the mobile phone and processing data are executed, thereby overall monitoring the mobile phone.

The phone also includes a power supply 590 (such as a battery) that powers various components.

Although not shown, the mobile phone may further include a camera, a Bluetooth module, and the like, and details are not described herein again.

In addition, each functional unit in each embodiment of the present invention may be integrated into one processing module, or each unit may exist separately and physically, or two or more units may be integrated into one module. The above integrated modules may be implemented in the form of hardware or software functional modules. If the integrated modules are implemented in the form of a software functional module and sold or used as an independent product, it may also be stored in a computer-readable storage medium.

In the embodiment of the present invention, it enters the video immersive playback mode by monitoring the page sliding status of the page, and in the video immersive playback mode, the information layout of the current video on the page is highlighted and other areas of the page except the information layout of the current video are darkened. Then the current video is played, allowing users to watch the content of the current video more focused. At the same time, in response to a preset switching instruction, based on the pre-loaded video list, the current video is switched to the corresponding target video, thereby simplifying the user's video switching operation, reducing the resource consumption of the terminal, saving user time, and improving the viewing experience.

At the same time, the embodiments of the present invention may request the target video resource from the service server when the current video is played, and then preload the target video when the current video is played. When switching from the current video to the target video, the target video can be played quickly, providing users with a smooth experience of switching and watching the target video.

In addition, the embodiments of the present invention also push different new video lists to different users according to specific policies. When the user finishes watching or is not interested in the videos in the current list, it will push new videos to the user based on the new video list, deliver different content video resources for the user, and improve the user viewing experience.

The above description is only part of the implementation of the present invention. It should be noted that, for those of ordinary skill in the art, without departing from the principles of the present invention, several improvements and modifications can be made. It should be regarded as the protection scope of this application.

1. A video playback control method, comprising the following steps:
entering a video immersive playback mode, when it is detected that a page sliding status is a preset status;
in the video immersive playback mode, determining information layout of a current video based on a preset baseline, highlighting an information layout of the current video in a page, and playing the current video after darkening areas other than the information layout of the current video on the page;
switching the current video to a corresponding target video based on a pre-loaded video list in response to a preset switching instruction; and
playing the target video.

2. The method as recited in claim 1, wherein it is determined whether to enter the video immersive playback mode by monitoring the page sliding status.

3. The method as recited in claim 2, wherein when the video list is detected to be in a SCROLL_STATE_TOUCH_SCROLL state, it is determined that the page sliding status is a preset state, and the video immersive playback mode is entered.

4. The method as recited in claim 3, wherein in the video immersive playback mode, a picture area of the current video in the page is highlighted and other areas are darkened.

5. The method as recited in claim 2, wherein when it is monitored that the video list is in a SCROLL_STATE_FLING state and the list is in an inertial sliding state, no immersive changes are made.

6. The method as recited in claim 1, wherein when an upper edge and a lower edge of a border of the video cover the baseline, a corresponding video is determined as the current video.

7. The method as recited in claim 1, wherein playing the target video comprises:
requesting a target video resource from a service server; and
loading the target video resource returned by the service server and play the target video.

8. The method as recited in claim 1, wherein before the step of switching the current video to a corresponding target video based on a pre-loaded video list in response to a preset switching instruction, further comprising:
when playing the current video, requesting a target video resource corresponding to the current video from a service server based on a pre-loaded video list; and
preloading the target video according to the target video resource.

9. The method as recited in claim 1, wherein the step of switching the current video to a corresponding target video based on a pre-loaded video list in response to a preset switching instruction comprises:
generating a corresponding switching instruction in response to a user's sliding operation on the current video; and
according to the switching instruction, the current video is switched to a corresponding target video based on the pre-loaded video list.

10. The method as recited in claim 1, wherein the step of switching the current video to a corresponding target video based on a pre-loaded video list in response to a preset switching instruction comprises:
at the end of the current video playback, generating a corresponding switching instruction; and
according to the switching instruction, switching the current video to the corresponding target video based on the pre-loaded video list.

11. The method as recited in claim 1, wherein switching the current video to a corresponding target video comprises:
replacing the information layout of the current video with the information layout of the target video as the information layout of the new current video; and
highlighting the information layout of the new current video and darkening other areas of the page other than the information layout of the new current video.

12. The method as recited in claim 1, further comprising:
receiving an update instruction for updating the video list, and requesting from a server for a new video list determined based on a specific policy;
in response to a preset switching instruction, switching the current video to a corresponding target video based on the new video list; and
playing the target video.

13. The method as recited in claim 12, wherein the specific policy includes a video push policy based on a user portrait or a video push policy based on a platform operation, or a video push policy based on a video ranking.

14. The method as recited in claim 13, wherein the user portrait is created according to the user's viewing history of the video and the attention paid to a video author.

15. A video playback apparatus, comprising:
a response module, for entering a video immersive playback mode in response to an immersive playback instruction enacted upon a video;
a processing module: in the video immersive playback mode, playing the current video after interactive elements on the page other than the current video playback interface are hidden;
a video switching module, for switching the current video to a corresponding target video based on a pre-loaded video list in response to a preset switching instruction; and
a playing module, for playing the target video.

16. A terminal, comprising:
one or more processors;
memory; and
one or more applications, wherein the one or more applications are stored in the memory and configured to be executed by the one or more processors, and the one or more applications are configured to execute the video playback control method according to claim 1.

17. A computer-readable storage medium having stored therein a computer program that, when executed by a processor, implements the video playback control methods according to claim 1.
